(19) United States
(12) Patent Application Publication
(10) Pub. No.: US 2026/0161745 A1
(43) Pub. Date: Jun. 11, 2026

(54) ADAPTIVE PATTERN MATCHER WITH MULTIDIMENSIONAL PREDICTORS

(71) Applicant: THROUGHPUTER, INC., Alexandria, VA (US)

(72) Inventor: Mark Henrik Sandstrom, Alexandria, VA (US)

(73) Assignee: THROUGHPUTER, INC., Alexandria, VA (US)

(21) Appl. No.: 19/320,326

(22) Filed: Sep. 5, 2025

Related U.S. Application Data
(60) Provisional application No. 63/730,452, filed on Dec. 11, 2024.
(60) Provisional application No. 63/739,049, filed on Dec. 26, 2024.
(60) Provisional application No. 63/739,554, filed on Dec. 28, 2024.
(60) Provisional application No. 63/742,377, filed on Jan. 6, 2025.
(60) Provisional application No. 63/745,760, filed on Jan. 15, 2025.
(60) Provisional application No. 63/808,741, filed on May 20, 2025.

(51) Int. Cl. G06F 18/2413; G06F 18/15; G06F 18/22

(52) U.S. Cl. CPC G06F 18/2413; G06F 18/15; G06F 18/22

(57) ABSTRACT

This disclosure describes systems and methods for predicting latent features of incoming objects by pattern-matching observable predictor features of such objects against corresponding features of dynamic collections of labeled objects organized according to their ascertained values of their latent features, with at least some of the predictor or latent features being multi-dimensional.

### CROSS-REFERENCE TO RELATED APPLICATIONS

This application claims the benefit of the following applications:
[I] U.S. Provisional Patent Application Ser. No. 63/730,452, entitled “Generation of Training Samples for Pattern-matching based Authentication”, filed on Dec. 11, 2024;
[II] U.S. Provisional Patent Application Ser. No. 63/739,049, entitled “Suspect Login Attempt Handling”, filed on Dec. 26, 2024;
[III] U.S. Provisional Patent Application Ser. No. 63/739,554, entitled “Dynamic Authentication Quiz Processing”, filed on Dec. 28, 2024;
[IV] U.S. Provisional Patent Application Ser. No. 63/742,377, entitled “Adaptive Pattern Matching”, filed on Jan. 6, 2025;
[V] U.S. Provisional Patent Application Ser. No. 63/745,760, entitled “Multi-Dimensional Predictors”, filed on Jan. 15, 2025; and
[VI] U.S. Provisional Patent Application Ser. No. 63/808,741, entitled “Inauthentic Account Recovery Prevention”, filed on May 20, 2025.

This application further is related to the below US patent publications:
[VII] U.S. Utility patent Ser. No. 11/561,983, entitled “Online Trained Object Property Estimator”, filed on Mar. 6, 2020;
[VIII] U.S. Utility patent Ser. No. 11/599,624, entitled “Graphic Pattern-Based Passcode Generation and Authentication”, filed on Jun. 5, 2020;
[IX] U.S. Utility patent Ser. No. 11/604,867, entitled “Graphic Pattern-Based Authentication with Adjustable Challenge Level”, filed on Mar. 30, 2020;
[X] U.S. Utility patent Ser. No. 11/620,557, entitled “Online Trained Object Property Estimator”, filed on Feb. 22, 2020;
[XI] U.S. Utility patent Ser. No. 11/893,463, entitled “Online Trained Object Property Estimator”, filed on Jan. 10, 2023; and
[XII] U.S. Utility patent Ser. No. 12/306,929, entitled “Graphic Pattern-based Authentication with Adjustable Challenge Level”, filed on Feb. 2, 2023.

All preceding applications are incorporated by reference herein in their entireties.

### BACKGROUND

### Technical Field

This disclosure pertains to the field of continuously trained machine learning (ML) and streaming prediction systems, particularly those having an adaptive training impact of incremental labeled events (objects) and/or using multi-dimensional predictor features for predicting the outcome-labels for incoming objects.

### Descriptions of the Related Art

Conventional ML based prediction methods have separate training and execution modes, causing them to perform poorly in time-variable operating environments. Moreover, traditional ML and prediction systems rely on predictor features that customarily are one-dimensional and represent only a sampled value for a given variable. With such one-dimensional predictors, the predictions will not be able to consider in which direction a given predictor value is moving, which can lead to mispredictions confusing polar-opposite outcomes. There thus is a need for techniques enabling prediction-environment-adaptive ML, as well as forming and using multi-dimensional predictor features that represent, besides their present value, also e.g. their direction and rate of change, among further augmented dimensions created from series of observed values for the monitored variables.

### SUMMARY

An aspect of the invention involves systems and methods for predicting latent attribute values for a stream of objects (modeling events or artifacts as a set of data attributes), such systems and methods involving, for any given object in a series of incoming objects, steps for (a) storing a feature vector (FV) based on readily observable attributes of the given object, (b) predicting a value for a latent attribute of the given object, (c) assigning a label for the given object by ascertaining a value for its latent attribute, (d) populating said label for the latent attribute in the FV of the given object, making it a labeled object, and (e) pushing said labeled object in to the appropriate one of the shift registers (SRs) holding objects accordant with their labels, wherein said predicting is done based on relative differences between the FV of the given incoming object and the FVs of the labeled objects placed in their respective label-specific SRs, where, according to various embodiments, the lengths of one or more of the SRs are adjusted in responses to matches and mismatches between the predicted and ascertained labels for the stream of objects. The techniques described herein thus allow the ML prediction models to adapt continuously based on the ascertained outcomes for the previously made predictions, while adjusting the adaptivity of training model collections based on changes in accuracy of the streaming predictions.

A further aspect of the invention involves systems and methods for forming and making predictions based on multidimensional predictor features (MPFs), in a feature vector (FV) thereof, a given MPF characterizing observable aspects of a given object in a series of objects, involving (1) assigning as a first dimension of the MPF a present value of a variable of the given object, (2) assigning as additional dimensions of the MPF one or more of the following: (a) a measure of difference, or delta, between the present and a previously sampled value of the first dimension of the predictor feature, (b) a measure of change between the present and a previous value of said delta, (c) a measure of change between the present and a set of previous values of the first dimension of the predictor feature, (d) a measure of change between (i) the present and more recent previous values of the first dimension of the predictor feature and (ii) the present and less recent previous values of the first dimension of the predictor feature, and/or (e) a computation based on values of at least some of the aforementioned dimensions of the predictor features of the FV. Moreover, embodiments of the invention involve ascertaining values for the to-be-predicted, latent features for the objects, maintaining collections of such outcome-ascertained i.e. labeled object, and making predictions for the latent features of incoming objects by pattern-matching the coordinate-values of the MPFs of a given incoming object to those of the labeled objects.

### BRIEF DESCRIPTION OF THE DRAWINGS

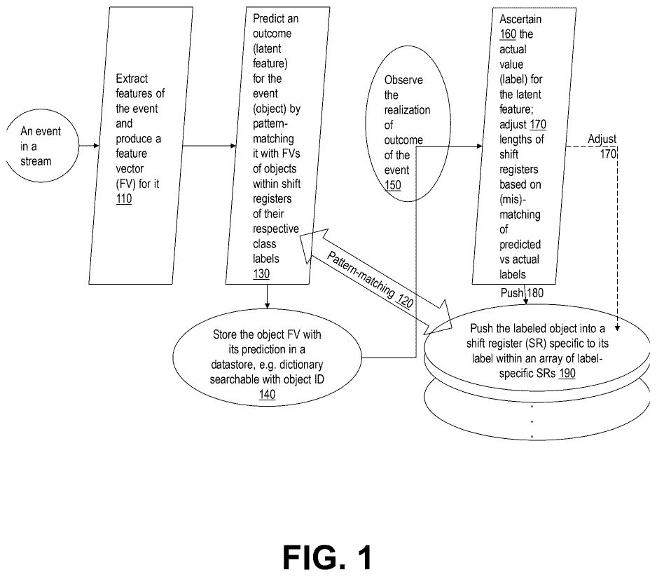

The drawings and tables (collectively, diagrams), which are incorporated in and constitute a part of the specification, illustrate one or more embodiments and, together with the description, explain these embodiments. Any values and dimensions illustrated in the diagrams are for illustration purposes only and may or may not represent actual or preferred values or dimensions. For clarity, some features of embodiments may be omitted from the drawings to assist in focusing the diagrams to the features being illustrated. In the drawings, FIG. 1 is a flow chart of a process for producing predictions for latent (to-be-predicted) features i.e. outcome labels for a stream of events, modeled as feature vectors (FVs), based on pattern matching the populated i.e. predictor features of incoming FVs with those of dynamic collections labeled FVs. The Table 1 within this detail description illustrates formation and usage of multidimensional predictor features (MPFs), in a context illustrated in FIG. 1 (specifically, regarding its elements 110, 120 and 130).

General symbols and notations used in the drawings:
Boxes indicate a functional module comprising digital logic.
Arrows indicate a digital signal flow. A signal flow may include one or more parallel bit wires. The direction of an arrow indicates the direction of primary flow of information associated with it with regards to discussion of the system functionality herein, but does not preclude information flow also in the opposite direction. A gapped arrow indicates a control, rather than primary data, flow.
An arrow reaching to a border of a hierarchical module of a group of modules indicate connectivity of the associated information to/from all associated sub-modules.
Lines or arrows crossing in the drawings are decoupled unless otherwise marked.
For clarity of the drawings, generally present signals for typical digital logic operation, such as clock signals, or enable, address and data bit components of write or read access buses, are not shown in the drawings.
   The drawing element reference numerals, e.g., pattern matching (120), are in the detail description that follows placed in parentheses to make it clear when a number refers to a drawing element, rather than to its numeric value.

### DETAILED DESCRIPTION

The description set forth below in connection with the diagrams is intended to be a description of various, illustrative embodiments of the disclosed subject matter. Specific features and functionalities are described in connection with each illustrative embodiment; however, it will be apparent to those skilled in the art that various embodiments may be practiced without each of those specific features and functionalities, as well as with modifications thereof.

In reference to FIG. 1, according to the herein studied embodiment, in response to incoming event (e.g., a detection of a physical article or occurrence by sensors, and/or an online situation observed digitally, etc.), the system per FIG. 1 creates a feature vector (FV) capturing values (110) for a set of readily observable attributes i.e. predictor features (PFs) characterizing the incoming event, referred to as an object, in a stream thereof. From the captured FV for any given incoming object, the system is to make a prediction (130) for the value of its latent attribute of interest, where a timely, correct prediction for the value of that latent attribute, i.e., event outcome (150), is of value for an application using the streaming machine-learning (ML) based prediction system per FIG. 1. In at least certain scenarios, the operation of the system per FIG. 1 involves steps per below.

To form the values for the PFs of the FV (110), the measurements or observations for characteristics of a given incoming object are normalized to occupy a defined value range (e.g. 0 to 255), preferably without concentration on any narrow sub-range across the labels of the classes for the outcome-of-interest (150). Moreover, in at least some embodiments, a dimensionality reduction procedure, e.g. eigen value decomposition or singular value decomposition (SVD) based principal component analysis (PCA) and/or linear discriminant analysis (LDA), is applied on the normalized attributes to form (110) components of the final FV characterizing the given object. These steps are done for improved consistency of accuracy of the predictions (130), by limiting impacts of any outlier measurements as well as of PFs carrying little to no predictive power over the outcome-labels (150) to be predicted, and improving separability of the labeled outcome-classes.

For the completed FV of the incoming object, per each given labeled class of the outcomes (150), an average of the distances to the sample FVs of the given class held in the respective shift-register (SR) (190) is computed, with a predicted (130) outcome for the object being based on the class or classes for which such average is smallest (120). The vector distance between the incoming FV and a FV in a given class-specific SR can be computed (120) for instance using block distance, i.e., by summing up component-wise absolute differences between the pair of FVs. In some embodiments, the sample FVs kept in the outcome-class specific SRs will also hold a value representing the relative strength of the outcome associated with the FV within its class, e.g., in a range of relative magnitude such as 1 to 8. In such embodiments, the magnitude values i.e. strength factors of the labeled FVs (190) can be used as their weighting coefficients in the computation (120) of the vector distance averages for each class. Further, in such embodiments, the prediction (130) for the given incoming object includes, besides the prediction for its outcome class, also a prediction for its relative magnitude (e.g. in the range of 1 to 8) in the predicted class, e.g. based on an average of the respective strength values of the labeled FVs (190) in the class that the incoming FV was matched (120) with, weighted by inverses of the respective vector distances between such FV pairs. In at least some embodiments, neutral or safe default values for predictions are defined, which the system per FIG. 1 will predict for the incoming objects at the system startup until there are sufficient numbers of actual-class-labeled FVs held in the class-specific SRs (190), and/or when at least two shortest distances (120) of the incoming FV (110) to the averaged FVs within the label-specific SRs (190) are within a defined threshold, configured to prevent the system per FIG. 1 from making a prediction between such competing labels in cases of close races.

The prediction value(s) (130) for each given incoming object is populated for its FV that will be kept in a datastore (140) such as a look-up-table or dictionary (addressable with an object ID based e.g. on its Internet timestamp value) until the actual outcome (150) for the associated event is ascertained (160), at which time the assessed value for the class, and possibly the strength factor, are populated (160) in the FV of the object that is pushed (180) into the SR (190) associated with its actual outcome class (150, 160), from which, in case the SR (190) already held its set quota of class-labeled FVs, the oldest FV thus gets pushed (180) out. In certain embodiments, the set of labels for classes and subclasses of the outcome (150) of the interest can be dynamic, with capabilities for online class label defining included with the label ascertainment logic (160). Yet in some embodiments, the incoming objects can have the outcome-label value prepopulated in their FVs, such that they are directly pushed (180) to their label-specific SRs (190), and cause online learning of outcome-class labels for the ascertainment function (160). Even for such training objects with outcome-labels present at the input to the system, embodiments of the system per FIG. 1 will make respective predictions 130 (without consulting the prepopulated label values), for purposes including monitoring the accuracy of the predicted vs. actual (prepopulated) values of the labels and thus calibrating the prediction system parameters, incl. via adjusting (170) the lengths of the pertinent SRs. Various embodiments of a prediction system per FIG. 1 will also have capabilities for deleting labels from the set of active labels used for predicting (130) and ascertainment (160), e.g., via feeding at the system input a training object with the appropriate value prepopulated for the label attribute, along with object header fields set for values defined for removal of such label value from the set of active labels to be used by the prediction system.

Further, in at least some embodiments, said quota for outcome-class labeled FV samples kept in a given class-specific SR (190) (having a default length at the system startup) is increased (190), up to a set maximum limit, in response to instances of the ascertained outcome class (160) matching the prediction (130) thereof for a given object, while such quota is decreased (190), down to a set minimum limit, in response to instances of the ascertained outcome class not matching the prediction thereof for a given object, in order to make the (feature value averages of) collections of labeled FVs (190) for the predicted and/or ascertained classes adapt to changes in the prediction environments faster when observed to be necessary via non-matching predictions for the confused classes. For the herein studied pattern-matching based predictions, where the predicted outcome (130) for an event is the label of the class for whose samples (190) the incoming FV had the shortest average distance to (120), only the latest FVs in any given class-specific SR (190) up to the active length of the given SR (quota of labeled FVs (190) kept for the given outcome class) are thus used for computing the respective classes' average of vector distances from the incoming FV. For instance, a default length of the class-specific SRs (190) could be 8, which would be incremented (170) by 1, up to a maximum such as 32 FVs, for the SRs of the predicted and actual classes in response to instances of the prediction (130) matching the ascertained actual outcome (150, 160) for any given events, while the active length of the SRs (190) for the predicted (130) and actual (160) classes could be divided by 2 (and rounded up, and floored at minimum of e.g. 2 samples) (170) in response to incidents of non-matches between the predicted and actual outcome for the stream of events.

In some embodiments, the predictor features (PFs) of the FVs used for pattern matching (120) are multidimensional i.e. vectors on themselves, e.g., with the first component corresponding to the current value (most recent recording) of the given variable, and the second component reflecting the change between the two most recent recordings of that given variable, or some other relation among the PFs of a FV representing (110) a given incoming object, e.g. a sum or difference between a pair of PFs of the FV. These multidimensional PFs (MPFs) within the FVs can naturally contain more than two components. Practical examples, including illustrative diagrams and computation formulas, for usage of such MPFs for pattern-matching (120) based predictions are included in the referenced provisional application [V].

Moreover, principles for formation (110) and usage (120) of MPFs are discussed below in reference to Table 1, showing parts of FVs (representing successive incoming objects) having PFs A and B (and potentially more features), where the computation of the four components of the MPF A (A[0] through A[3]) are furthermore depicted:

TABLE 1

| | Feature: | | | | | |
|---|---|---|---|---|---|---|
| | A | | | | B | . . . |
| | Component: | | | | | |
| | | 1 | | 3 | | |
| | | Change | 2 | A[0] to | | |
| | 0 | from | Change | B[0] | 0 | |
| | Present | previous | of | ratio, | Present | |
| | value of | value, | change, | centered | value of | |
| | feature A | centered | centered | at 128, | feature B | |
| Observation | [0, 255] | at 128 | at 128 | [0, 255] | [0, 255] | . . . |

| | | | | | |
|---|---|---|---|---|---|
| 4 | 90 | 183 | 153 | 255 | 30 |
| 3 | 35 | 158 | 255 | 64 | 70 |
| 2 | 5 | 3 | 0 | 8 | 80 |
| 1 | 130 | 208 | | 128 | 130 |
| 0 | 50 | | | 32 | 200 |

Table 1 shows a series of five observations of the predictor features A and B for the FV schema under the study, captured as component 0 of said features, and denoted as A[0] and B[0]. The component 1 of feature A in this example measures the change between the successive values of A[0], computed as A[1]=128+A[0]−A′[0], where A′ is the previous observation. E.g., for the observation at row 3, A[1] thus is 128+35−5=158 (all components of this exemplar FV are cast to range [0,255]). The component A[2], measuring change of the change in A, is computed as 128+A[1]−A′[1]. The component A[3], reflecting the ratio of present values of A and B, for this example of a multidimensional predictor is computed as max(0,min(255,round(128*(A[0]+k)/(B[0]+k))), where k (a positive number) is normalization constant, e.g. in the range from 1 to 64. Based on such examples, additional forms of components for MPFs can be devised by those skilled in the relevant arts.

Once the feature-to-be-predicted, referred to as the Y variable for the FVs, is ascertained (160), according to embodiments of the herein described system, such Y-value labeled FVs are pushed (180) to their respective label-specific SRs (190), for pattern-matching (120) with further incoming (unlabeled) observation FVs in order to produce the predictions (130) for their Y-values. In some scenarios, the predictions (130) are based on the Y-values of the closest matching (120) labeled FVs (190), where closeness can be assessed by computing a vector distance between the FV of the incoming observation and any given labeled FV, for example by adding up the absolute values of their component-wise differences, across all dimensions, including the sub-components of any MPFs among the FVs, such as the feature A per Table 1. Besides the method of finding the labeled-outcome class whose FVs (190) on average are closest to the incoming FV as described above, various embodiments can determine the predicted label for the incoming FV using e.g. a K-nearest-neighbors (where K is a positive integer, e.g. 8) algorithm that matches the incoming FV with the most common label among its K closest labeled FVs in the SRs (190).

In certain applications, techniques such as eigen or singular value decomposition based Principal Component Analysis (PCA) and/or Linear Discriminant Analysis (LDA) are used for dimensionality reduction among the FV components, in order to improve consistency of prediction accuracy. According embodiments where LDA is used, the LDA transformation model is fitted using the labeled FVs (190) for training, and the resulting transformation is applied for the incoming FV, for pattern matching (120) with the similarly transformed labeled FVs (190) in the reduced-dimensionality coordinate system, where the LDA is used to transform the as-captured (110) FVs to ones having fewer components that each have higher correlation with, and thus better predictive power, over the latent feature to be predicted (130). In some usage cases, the internal components of any MPFs among the FVs are flattened (presented as independent features) before the PCA and/or LDA transformations. Yet, in some usage cases, e.g. SVD based PCA is applied for dimensionality reduction among each MPF, before the LDA transformation for the final reduced coordinates used for pattern matching (120).

According to certain embodiments, as an alternative or in addition to the FV dimensionality reduction techniques per above, each predictor feature in the FV schema (110), including each MPF dimension, is assigned its respective relevance factor (RF), such that, in the pattern-matching and predicting functions (120, 130), said dimension-specific RFs are used as multipliers of their respective contributions for vector distance metrics between the FV of the given incoming object (110) and the labeled FVs in the array of label-specific SRs (190). In at least some of such embodiments, per each given MPF dimension, for each given incoming object, a dimension-specific prediction for its label is made such that considers purely the projections of the distances from the given incoming object FV (110) to the labeled FVs (190) along that given dimension (e.g., dimension A[3] in Table 1), where the respective RF for any given dimension of the MPF is adjusted up or down (to defined respective max and min limits) based on whether the ascertained (160) labels for the series of incoming objects match or mismatch the respective dimension-specific predictions (130) thereof.

One or more of the above described techniques can be used in digital and online authentication applications, e.g., per the referenced provisional applications [I], [II], [III] and [VI].

Besides the users' login attempt authenticity affirmation feedback techniques per these mentioned references [I] etc., applications of the techniques per this disclosure for login attempt (or generally online visitor or transaction) authenticity prediction may use login (etc. online transaction) candidate voice recording based FVs (along with the username typing pattern based FVs), and in some applications, the labeling (160) of the FVs for authentic or inauthentic classes and any respective sub-types may involve providing, e.g. via an audio file attached to or linked from an email asking the authentic user to affirm the authenticity of a given login attempt, the user with an opportunity to play back the voice recording captured at the given login (or other transaction) attempt for the user to accordingly provide feedback to the system by affirming the case regarding authenticity of the respective attempt, along with identification of any applicable sub-class, e.g., inauthentic female voice, inauthentic male voice, inauthentic non-human-voice, or inauthentic inaudible (silence), as such subclasses may have their distinct clusters in the applicable feature spaces of the voice recognition FVs. Furthermore, as an alternative or in addition to such voice recording, authentication or authorization applications of techniques per the present disclosure and the referenced applications [I]-[VI] may use transaction (e.g. funds transfer) submitter candidate photo or video recordings, for pattern matching (120) based authenticity prediction, as well as for the user to ascertain (160) the truth concerning authenticity thereof, and applicable subclasses in case of inauthentic transaction attempts, based on a display or replay of photo or video captured of the submitter candidate at any given attempt of a sensitive transaction. These augmented authentication and authenticity ascertainment methods will improve the accuracy of the users' affirmations (160) of the transaction attempt authenticity or inauthenticity classes and subclasses, as well serve as a deterrent against inauthentic login etc. transaction attempts, by exposing the party attempting an unauthorized transaction and capturing suspect-identifying evidence of such attempts. Naturally, corresponding methods per FIG. 1, the references [IV] and [V], and this paragraph can be used in application fields of this disclosure beyond authentication, practically wherever user or calling application feedback could be used for continuous training of ML based prediction systems, such as recommendation systems suggesting information or commercial article selections for an online or mobile user, environmental or industrial monitoring and control systems producing alerts of likely events to occur and/or suggesting or actuating relevant corrective actions, etc.

Hierarchical and online trained pattern matching based ML and streaming prediction techniques per the referenced patents [VII], [X] and [XI] may be used in various embodiments of systems and methods per the present disclosure, illustrated in FIG. 1 and Table 1 and related descriptions. Implementations of authentication applications of embodiments of techniques per this disclosure can apply teachings in the referenced patents [VIII], [IX] and [XII].

The streaming data path functionality described herein, at least where not otherwise mentioned, can be implemented by hardware logic for minimized latency and maximized throughput (where hardware logic naturally also includes any necessary signal wiring, memory elements and such) with such hardware logic being able to operate without active software involvement beyond initial system configuration and any subsequent system reconfigurations. The hardware logic may be synthesized on a reprogrammable computing chip such as a field programmable gate array (FPGA) or other reconfigurable logic device. In addition, such hardware logic may be hardcoded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality. Aspects of the streaming data path functionality may be delivered via a network computing environment, such as a cloud computing environment.

### CONCLUSIONS

Generally, this description and drawings are included to illustrate architecture and operation of practical embodiments of the disclosure, but are not meant to limit its scope. For instance, even though the description does specify certain system elements to certain practical types or values, those of skill in the art will realize, in view of this description, that any design utilizing the architectural or operational principles of the disclosed systems and methods, with any set of feasible types and values for the system parameters, is within the scope of the teachings. Moreover, the system elements and process steps, though shown as distinct to clarify the illustration and the description, can in various embodiments be merged or combined with other elements, or further subdivided and rearranged, etc., without departing from the scope of the teachings. Finally, those of skill in the art will realize that various embodiments of the present disclosure can use different nomenclature and terminology to describe the system elements, process phases etc. technical concepts in their respective implementations. Generally, from this description many variants will be understood by those skilled in the art that are yet encompassed by the scope of the teachings as set forth herein.

What is claimed is:

1. A method, implemented using digital hardware and/or software logic, for predicting values for attributes-of-interest of objects, the method involving, for any given object in a series of incoming objects:
storing a feature vector (FV) based on observable attributes of the given object, said observable attributes referred as predictor features (PFs);
predicting a value for a latent attribute of the given object, with values for said latent features referred to as labels;
ascertaining a value for the latent attribute of the given object, with such an ascertained value referred as the actual label of the given object;
populating said actual label for the latent attribute in the FV of the given object, making it a labeled FV (LFV); and
placing said LFV in one shift register (SR) among an array of label-specific SRs holding LFVs of objects accordant with their labels,
wherein said predicting is done at least in part based on vector distance metrics between FV of the given object and the LFVs placed in their respective SR within the array of label-specific SRs.

2. The method of claim 1, wherein there is
a set of discrete labels according to which the incoming objects are labeled, and
an SR associated with each label among the set of discrete labels.

3. The method of claim 2, wherein the predicting is done based on computing vector distance metrics between the FV of the given object and the LFVs placed in their respective SR within the array of label-specific SRs.

4. The method of claim 3, wherein the predicting the label for the given object is based on the label associated with an SR of the array whose respective vector distance metric is the smallest, where said metric for any given label corresponds to an average of distances between the FV of the given object and the LFVs in the SR of that given label.

5. The method of claim 3, wherein
the ascertaining of the actual label for a given object involves assigning a strength factor (SF) representing how strongly that given object represents its label, and
the computing of the vector distance metrics uses the SFs of the LFVs as weighted sum coefficients such that, among LFVs in an SR associated with a given label, an LFV with a higher SF will have relatively more impact on the vector distance metric for the given label than an LFV with a lower SF.

6. The method of claim 3, wherein the vector distance metric for a label of a given SR, among the array of label-specific SRs, is based on computing
a sum of vector distances from the FV of the given object to each of the LFVs in the given SR,
an average of vector distances from the FV of the given object to the LFVs in the given SR, and/or
vector distances between the FV of the given object and an averaged FV of the LFVs in the given SR.

7. The method of claim 5, wherein the predicting involves, besides predicting the label for the given object, also predicting its SF value as a FV labeled for that labeled class, where said predicting of the SF value for the given object is based on a weighted average of the SFs of a set of LFVs in the SR associated with the label predicted for that given object, with weighting coefficients for such a weighted average computation being based on respective inverse values of vector distances of said set of LFVs from the FV of the given object.

8. The method of claim 1, wherein a normalization procedure is applied among the PFs of the given object such that, for the series of incoming objects, the normalized values of any given PF occupy same defined value range.

9. The method of claim 1, wherein a dimensionality reduction procedure is applied among the PFs of the series of incoming objects to produce their FV components for the predicting step.

10. The method of claim 1, wherein the placing of a LFV in a given one of the SRs involves, in case the given SR contains at least a set quota of LFVs to be held in it, elimination of one or more LFVs from that given SR.

11. The method of claim 10, wherein the LFVs eliminated from the given SR includes the LFV that had been longest in that SR.

12. The method of claim 10, wherein among the LFVs eliminated from the given SR is,
in case there are one or more LFVs in that SR that have been there for at least a defined duration, the LFV that had been longest in that SR,
and otherwise, the LFV whose associated strength factor is lowest among the LFVs within that SR.

13. The method of claim 10, wherein
in response to an incident where predicted and actual labels for the given object do not match, the set quota of LFVs to be held in the SRs associated with the predicted and/or actual labels for that given object is decreased, and/or
in response to an incident where predicted and actual labels for the given object match, the set quota of LFVs to be held in the SRs associated with the label predicted for that given object is increased.

14. The method of claim 10, wherein,
in response to an incident where predicted and actual labels for the given object do not match, the set quota of LFVs to be held in each of the array of SRs is decreased, and/or
in response to an incident where predicted and actual labels for the given object match, the set quota of LFVs to be held in each of the array of SRs is increased.

15. The method of claim 2, wherein the set of discrete labels involves a neutral default class, which is predicted in cases where
at least some of said vector distance metrics are within a defined threshold from each other, and/or
there are insufficient amounts of LFVs in the array of SRs.

16. The method of claim 1, involving a procedure of forming at least one multidimensional PF (MPF), said procedure comprising:
assigning as a value for one dimension of the MPF a present value of an observable attribute associated with the series of incoming objects, said one dimension referred to as a primary component, and assigning as a value for a further dimension of the MPF at least one of:
a) a measure of difference between present and previous values of the primary component, said measure referred to as a delta component, and
b) a result of a defined computation between values of different PFs of the FV,
where such MPF dimensions are considered as independent PFs for the predicting step.

17. The method of claim 16, involving assigning as values for one or more additional dimensions for the MPF one or more of the following:
a measure of difference between present and previous value of the delta component of the of the MPF,
a measure of difference between the present and a set of previous values of the primary component of the MPF,
a measure of difference between (i) the present and one set of previous values of the primary component of the MPF and (ii) the present and another set of previous values of the primary component of the MPF, and/or
a computation based on values of any of the aforementioned dimensions of the MPF.

18. The method of claim 16, where each PF, including each MPF dimension, is assigned its respective relevance factor (RF), and where, for the predicting step, said dimension-specific RFs are used as scaling factors of their respective contributions for the vector distance metrics between FV of the given object and the LFVs placed in their respective SRs of the array.

19. The method of claim 18, where
per each given MPF dimension, a dimension-specific prediction for the label is made such that considers just the projections of the distances from the given object FV to the LFVs along its specific dimension, and
the respective RF for any given dimension of the MPF is adjusted based on whether actual labels for the series of incoming objects match the respective dimension-specific predictions thereof.

20. A system implementing the method of claim 16.
